(19) United States
(12) Patent Application Publication
(10) Pub. No.: US 2024/0150031 A1
(43) Pub. Date: May 9, 2024

(54) AVIATION PROPULSION SYSTEM FOR AN AIRCRAFT

(71) Applicant: ZF FRIEDRICHSHAFEN AG, Friedrichshafen (DE)

(72) Inventor: Joerg LITZBA, Fuldatal (DE)

(73) Assignee: AIRBUS HELICOPTERS TECHNIK GMBH, Calden (DE)

(21) Appl. No.: 18/281,877

(22) PCT Filed: Mar. 10, 2022
(86) PCT No.: PCT/EP2022/056193

§ 371 Date: Sep. 13, 2023

(30) Foreign Application Priority Data
Mar. 15, 2021 (DE) 10 2021 202 487.4

(51) Int. Cl. B64D 35/00; F16D 9/06; F16H 57/02; F16H 57/038

(52) U.S. Cl. CPC B64D 35/00; F16D 9/06; F16H 57/038; F16H 2057/02043

(57) ABSTRACT

An aviation propulsion system for an aircraft with two engines, comprising respectively a connecting shaft which is rotatably drivable in rotation by one of the engines, wherein mutually facing ends of both connecting shafts are connected to each other or are connectable to each other in a rotatably drivable manner. Both connecting shafts are connected via their mutually facing ends in a rotatably drivable manner to one of the mutually facing ends of the connecting shafts via a openable coupling.

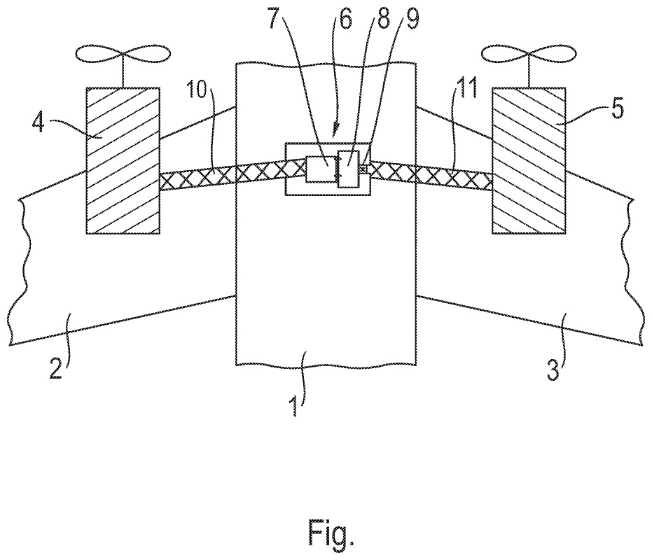

### CROSS-REFERENCE TO RELATED APPLICATIONS

This application is the U.S. national phase of PCT Application No. PCT/EP2022/056193 filed on Mar. 10, 2022, which claims priority to German Patent Application No. DE 102021202487.4 filed on Mar. 15, 2021, the disclosures of which are incorporated in their entireties by reference herein.

### TECHNICAL FIELD

The disclosure relates to an aviation propulsion system of an aircraft with two engines, comprising respectively a connecting shaft which is rotatably drivable by one of the engines, wherein mutually facing ends of both connecting shafts are connected to each other or are connectable to each other in a rotatably drivable manner.

### BACKGROUND

An aviation propulsion system of this type is known from EP 0 448 672 B1. In this regard, an auxiliary supply device of the aircraft is drivable by means of a gearbox assembly between the connecting shafts. The aircraft may, for example, be an aeroplane with two engines which are connected to each other by the connecting shafts. However, the disclosure may also advantageously be used in rotary wing aircraft with two engines which are connected to each other by the connecting shafts.

### SUMMARY

An objective of the disclosure is to provide an aviation propulsion system of the type described above which makes a plurality of operating modes possible and leads to greater operational safety with a low component requirement.

In accordance with the disclosure, this objective is achieved by both connecting shafts being connected via their mutually facing ends in a rotatably drivable manner to one of the mutually facing ends of the connecting shafts via an openable coupling.

The aircraft may, for example, be an aeroplane or a rotary wing aircraft.

As a result of this configuration, one engine can be switched off by opening the coupling. This comprises the advantage that this engine can be switched off in the event of a malfunction of an engine. The function of the other engine is not affected thereby and the further operation of the flight is not jeopardized.

One of the engines can also be switched off during the flight operation in order to save fuel, such as jet fuel, for example, by using only one engine.

A further possible type of operation consists in the fact that, during ground operations, for example after a landing, both engines do not have to be switched off. It is enough to switch off one of the engines and to open the coupling so that it is possible to move more flexibly and more rapidly and still save fuel during ground operations. Preferably in this regard, the engine located on the side of the cargo door is switched off.

Since only a single coupling is present, the number of components is kept low. This saves on both the installation space required and on weight. Furthermore, this leads to a reduction in the cost of the aviation propulsion system in comparison to the potential use of multiple couplings, as well as to an improvement in the reliability of the aviation propulsion system.

In order to be able to supply further devices with a rotary drive the engines, so that a separate drive is not required in order to save installation space and weight, one end of one of the connecting shafts may be connected in a rotatably drivable manner to the openable coupling via a gearbox unit, and the openable coupling may be connected in a rotatably drivable manner to one end of the second of the connecting shafts.

If an overload protection element which opens when a predetermined torque acting on the one of the connecting shafts is exceeded is arranged between the end of one of the connecting shafts and the gearbox unit or the coupling, then in the event of a fault in the engine connected to this connecting shaft and overloading of this connecting shaft, a separation of the faulty engine takes place immediately by opening the overload protection element, so that the other engine can continue to operate uninfluenced by this fault.

A compact design requiring only a small amount of installation space results when the coupling and/or the gearbox unit and/or the overload protection element form a structural unit.

The coupling and the gearbox unit and, if applicable, the overload protection element may be arranged in the center of a wing of the aircraft, wherein they may, for example, be arranged in a fuselage of the aircraft. Alternatively and preferably, the coupling and the gearbox unit may also be arranged in a wing structure in the area of the fuselage. In both cases, they are well protected from environmental influences and easily accessible for maintenance and repairs.

The two connecting shafts may be arranged coaxially with respect to each other.

However, it is also possible for the two connecting shafts to extend in a manner that deviates from coaxiality with respect to each other.

In this regard, so that the two connecting shafts can be connected to each other in a rotatably drivable manner and in a simple manner, the gearbox unit may be a bevel gear unit.

In a simple embodiment, the overload protection element may be a shear bolt.

A further device that can be driven by one of the engines may be an auxiliary supply device of the aircraft which can be drivable by means of the gearbox unit.

Examples of auxiliary supply devices are a hydraulic pump, a compressor or a generator.

### BRIEF DESCRIPTION OF THE DRAWING

An exemplary embodiment of the disclosure is shown in the drawing and will be described in more detail below. The single FIGURE of the drawing shows a diagrammatic representation of a section of a plan view of an aircraft.

### DETAILED DESCRIPTION

A first wing 2 and a second wing 3 extend opposite to each other from a fuselage 1 of the aircraft.

The first wing 2 carries a first engine 4 and the second wing 3 carries a second engine 5.

A structural unit 6 which consists of a gearbox unit 7, a openable coupling 8 and an overload protection element 9 is arranged in a housing between the two wings 2 and 3 in the fuselage 1.

A first connecting shaft 10 from the first engine 4 leads to the gearbox unit 7, which is therefore rotatably drivable by the first engine 4, the output opposite to the first connecting shaft 10 of which being connected to the coupling 8.

A second connecting shaft 11 leads from the second engine 5 via the overload protection element 9 to the coupling 8.

Thus, the first connecting shaft 10 and the second connecting shaft 11 are non-rotatably connected to each other via the gearbox unit 7, the coupling 8 of which is engaged during normal operation, and the overload protection element 9.

This connection which is fixed against rotation can on the one hand be disengaged by disengaging the coupling 8.

On the other hand, however, this connection which is fixed against rotation can also be broken by the overload protection element 9 when the torque acting on it exceeds a predetermined torque.

The two connecting shafts 10 and 11 extend at an angle with respect to each other, i.e. they are not coaxial with respect to each other. For this reason, the gear unit 7 is a bevel gear unit.

### REFERENCE NUMERALS

1 fuselage
2 first wing
3 second wing
4 first engine
5 second engine
6 structural unit
7 gearbox unit
8 coupling
9 overload protection element
10 first connecting shaft
11 second connecting shaft

1. An aviation propulsion system of an aircraft with two engines comprising respectively a connecting shaft which is rotatably drivable by one of the engines, wherein mutually facing ends of both connecting shafts are connected to each other or are connectable to each other in a rotatably drivable manner, wherein both connecting shafts are connected via their mutually facing ends in a rotatably drivable manner to one of the mutually facing ends of the connecting shafts via an openable coupling.

2. The aviation propulsion system of claim 1, wherein one end of one of the connecting shafts is connected in a rotatably drivable manner to the openable coupling via a gearbox unit, and wherein the openable coupling is connected in a rotatably drivable manner to one end of the second of the connecting shafts.

3. The aviation propulsion system of claim 1, wherein an overload protection element is arranged between the end of one of the connecting shafts and the gearbox unit or the coupling, which opens when a predetermined torque acting on the one of the connecting shafts is exceeded.

4. The aviation propulsion system of claim 1, wherein the coupling and/or the gearbox unit and/or the overload protection element form a structural unit.

5. The aviation propulsion system of claim 1, wherein the coupling and the gearbox unit and, if applicable, the overload protection element are arranged in the center of a wing in a fuselage of the aircraft or in a wing structure in the area of the fuselage.

6. The aviation propulsion system of claim 1, wherein the two connecting shafts are arranged coaxially with respect to each other.

7. The aviation propulsion system of claim 2, wherein the two connecting shafts extend in a manner that deviates from coaxiality with respect to each other.

8. The aviation propulsion system of claim 7, wherein the gearbox unit is a bevel gear unit.

9. The aviation propulsion system of claim 3, wherein the overload protection element is a shear bolt.

10. The aviation propulsion system of claim 2, wherein an auxiliary supply device of the aircraft is drivable by means of the gearbox unit.
